(19) United States
(12) Patent Application Publication
(10) Pub. No.: US 2024/0208605 A1
(43) Pub. Date: Jun. 27, 2024

(54) DRIVE SYSTEM FOR ELECTRIC ASSISTED BICYCLE, ELECTRIC ASSISTED BICYCLE, CONTROL METHOD FOR ELECTRIC ASSISTED BICYCLE, AND PROGRAM

(71) Applicant: Yamaha Hatsudoki Kabushiki Kaisha, Shizuoka (JP)

(72) Inventors: Toshihiko HIGASHI, Shizuoka (JP); Yoichiro HATTORI, Shizuoka (JP)

(21) Appl. No.: 18/395,640

(22) Filed: Dec. 25, 2023

(30) Foreign Application Priority Data
Dec. 27, 2022 (JP) 2022-210745

(51) Int. Cl. B62M 6/50; B62J 45/411; B62J 45/413; B62J 45/421; B62M 6/75

(52) U.S. Cl. CPC B62M 6/50; B62J 45/411; B62J 45/413; B62J 45/421; B62M 6/75

(57) ABSTRACT

When transitioning from a first control mode to a second control mode is satisfied, a control device starts to change an assist ratio from a first assist ratio to a second assist ratio at a change start position Ps between an angular position P1 obtained by adding 90 degrees to a crank angular position corresponding to an uppermost point P0 of a trajectory of a pedal and an angular position P2 obtained by adding 135 degrees to a crank angular position corresponding to the uppermost point P0. The control device changes the assist ratio such that the assist ratio reaches the second assist ratio at a change end position Pe obtained by adding at least 45 degrees to the change start position Ps. This system can reduce an impact on ride quality caused by the change in the assist ratio associated with the change in the control mode.

### CROSS-REFERENCE TO RELATED APPLICATION

The present application claims priority from Japanese application JP2022-210745 filed on Dec. 27, 2022, the content of which is hereby incorporated by reference into this application.

### BACKGROUND OF THE INVENTION

### 1. Field of the Invention

The present invention relates to a drive system for an electric assisted bicycle, an electric assisted bicycle, a control method for an electric assisted bicycle, and a program.

### 2. Description of the Related Art

Many electric assisted bicycles have multiple control modes, such as a mode with relatively high assist torque that is output from the electric motor and a mode with relatively low assist torque. JP2019-137119A discloses a timing for changing a mode (timing for changing an assist ratio) in one cycle of a pedal. Specifically, JP2019-137119A discloses that the assist ratio is changed when one of the pedals is at an angular position relatively close to the lowest point on the trajectory of the pedal.

As disclosed in JP2019-137119A, if the assist ratio is changed when one of the pedals is close to the lowermost point, the rider may find the ride uncomfortable.

### SUMMARY OF THE INVENTION

The present disclosure provides a drive system, an electric assisted bicycle, a control method of the electric assisted bicycle, and a program that can further improve a ride quality of the electric assisted bicycle when changing a control mode.

(1) A drive system for an electric assisted bicycle proposed in the present disclosure includes a sensor that detects pedaling force acting on a pedal attached to a crankshaft, an electric motor that assists a pedaling motion of the pedal, and a control device that controls the electric motor based on an assist ratio according to a control mode and the pedaling force detected by the sensor. The control device includes, as the control mode, a first control mode for controlling the electric motor based on a first assist ratio and a second control mode for controlling the electric motor based on a second assist ratio. When a condition for transitioning from the first control mode to the second control mode is satisfied, the control device starts to change the assist ratio from the first assist ratio to the second assist ratio at a change start position between a first angular position and a second angular position, the first angular position being an angular position obtained by adding 90 degrees to an angular position of the crankshaft corresponding to an uppermost point on a trajectory of the pedal, and the second angular position being an angular position obtained by adding 135 degrees to the angular position of the crankshaft corresponding to the uppermost point. The control device changes the assist ratio such that the assist ratio reaches the second assist ratio at a change end position obtained by adding at least 45 degrees to the change start position.

This drive system can reduce an impact on ride quality caused by the change in the assist ratio associated with the change in the control mode.

(2) In the drive system of (1), an angular difference between the change start position and the change end position may be equal to or less than 135 degrees. This can prevent an excessive amount of time required for changing the assist ratio.

(3) In the drive system of (1) or (2), an angular difference between the change start position and the change end position may be equal to or more than 60 degrees. This can more effectively prevent a sudden change in the assist torque caused by changing the control modes.

(4) In the drive system of (1) to (3), the change end position may be between an angular position obtained by adding 135 degrees to the uppermost point and an angular position obtained by adding 225 degrees to the uppermost point. When the crankshaft is in such an angular position, the pedaling force is weakened. In other words, changing the assist ratio is completed when the pedaling force is weakened. As such, the rider is less likely to feel the change in the assist ratio, and thus the ride quality can be further improved.

(5) In the drive system of (1) to (4), the change end position may be an angular position obtained by adding an angle equal to or less than 270 degrees to the uppermost point. This effectively prevents excessive delay in the start of the travel at the assist ratio according to the changed control mode.

(6) In the drive system of (1) to (5), the change end position may be an angular position obtained by adding an angle equal to or less than 225 degrees to the uppermost point. This effectively prevents excessive delay in the start of the travel at the assist ratio according to the changed control mode.

(7) In the drive system of (1) to (6), when the pedal is located in between the change start position and the change end position, the control device may calculate the assist ratio such that the assist ratio gradually approaches the second assist ratio from the first assist ratio.

(8) The drive system of (1) to (6) may include a sensor that detects an amount of change in the angular position of the crankshaft. When the pedal is located between the change start position and the change end position, the control device may calculate the assist ratio based on the amount of change in the angular position of the crankshaft. This enables easily changing the assist ratio between the change start position and the change end position.

(9) In the drive system of (1) to (8), the control device may calculate a rate of change in the assist ratio based on a difference between the first assist ratio and the second assist ratio and an angular difference between the change start position and the change end position. This easily enables completely changing the assist ratio when the angle of the crankshaft reaches the predetermined change end position.

(10) An electric assisted bicycle proposed in the present disclosure includes the drive system according to (1) to (9) and a wheel that receives an assist torque from the electric motor.

(11) A control method for an electric assisted bicycle proposed in the present disclosure controls an electric motor based on an assist ratio according to a control mode and pedaling force detected by a sensor and includes a first control mode and a second control mode as the control mode of the electric motor, where the first control mode controls the electric motor based on a first assist ratio and the second control mode controls the electric motor based on a second assist ratio. The control method starts to change the assist ratio, when a condition for transitioning from the first control mode to the second control mode is satisfied, from the first assist ratio to the second assist ratio at a change start position between a first angular position and a second angular portion, the first angular position being obtained by adding 90 degrees to an angular position of a crankshaft corresponding to an uppermost point of a trajectory of a pedal, and the second angular position being obtained by adding 135 degrees to the angular position of the crankshaft corresponding to the uppermost point. The control method changes the assist ratio such that the assist ratio reaches the second assist ratio at a change end position obtained by adding at least 45 degrees to the change start position.

(12) A program proposed in the present disclosure causes a computer to function as a control device that controls an electric motor based on an assist ratio according to a control mode and pedaling force detected by a sensor and includes a first control mode and a second assist ratio as the control mode of the electric motor, where the control device controls, in the first control mode, the electric motor based on a first assist ratio, the control device controls, in the second control mode, the electric motor based on a second assist ratio. The program causes the computer to start to change the assist ratio, when a condition for transitioning from the first control mode to the second control mode is satisfied, from the first assist ratio to the second assist ratio at a change start position between a first angular position and a second angular position, the first angular position being obtained by adding 90 degrees to an angular position of a crankshaft corresponding to an uppermost point of a trajectory of a pedal, the second angular position being an angular position obtained by adding 135 degrees to the angular position of the crankshaft corresponding to the uppermost point. The program causes the computer to change the assist ratio such that the assist ratio reaches the second assist ratio at a change end position obtained by adding at least 45 degrees to the change start position.

### BRIEF DESCRIPTION OF THE DRAWINGS

FIG. 1 is a side view of a vehicle proposed in the present disclosure as an example;

FIG. 2 is a block diagram showing a structure of an electric assisted bicycle;

FIG. 3 is a block diagram showing functions of a control device;

FIG. 4 is a diagram for showing a change start position and a change end position related to a change of an assist ratio;

FIG. 5 is a time chart of processing performed by a peak pedaling force detecting unit and a start position detecting unit;

FIG. 6 is a flow chart showing processing related to a change of a control mode executed by the control device;

FIG. 7 is a flow chart showing another example of processing related to a change of a control mode executed by the control device;

FIG. 8 is a time chart showing an example of a result of processing performed by the control device; and

FIG. 9 is a time chart showing another example of a result of processing of the control device.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

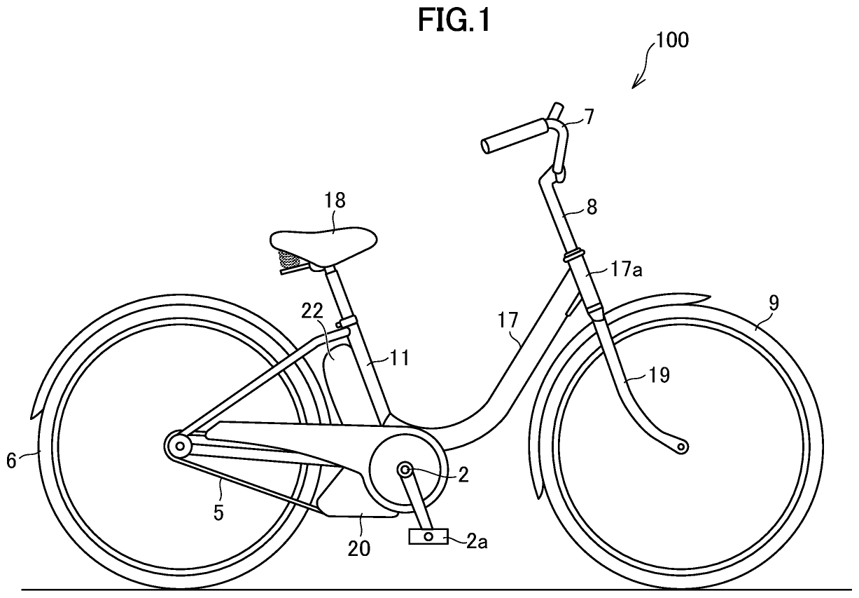

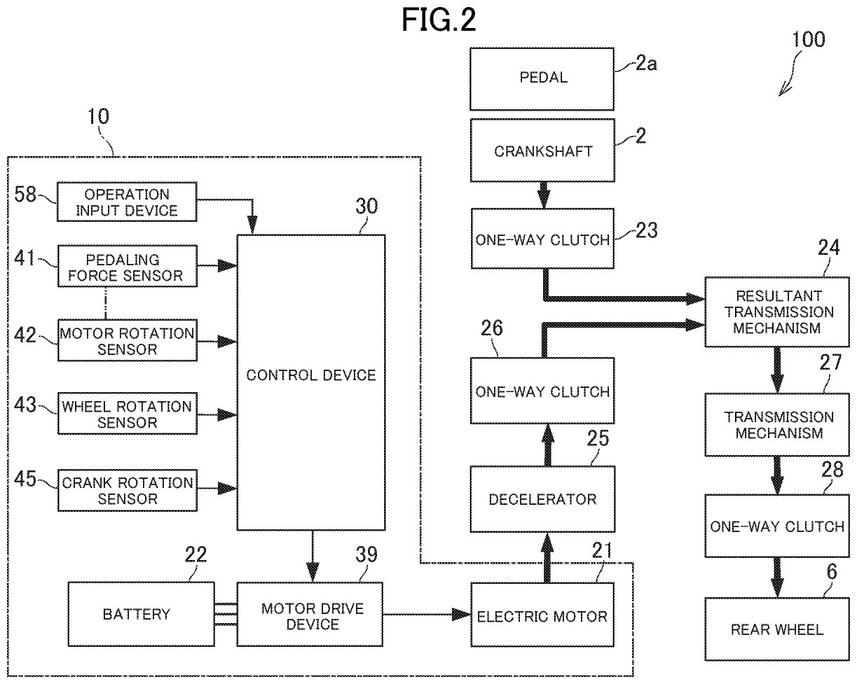

FIG. 1 is a side view of an electric assisted bicycle 100 as an example of the electric assisted bicycle proposed in the present disclosure. FIG. 2 is a block diagram showing a structure of the electric assisted bicycle 100. In FIG. 2, a thick solid line represents power transmission, and a thin solid line represents a signal or a current. The electric assisted bicycle 100 includes a drive system 10 for assisting the rider in pedaling. The drive system 10 includes electric components such as an electric motor 21, a control device 30, a motor drive device 39, and an operation input device 58, which will be described later. In the following, the electric assisted bicycle 100 will be simply referred to as a bicycle.

### [Hardware of Electric Assisted Bicycle]

As shown in FIG. 1, the bicycle 100 has a crankshaft 2. A right pedal 2a and a left pedal 2a are respectively attached to the right end and the left end of the crankshaft 2 via a crank arm. The crankshaft 2 is supported at a lower end of a seat tube 11. A saddle 18 is fixed to an upper end of the seat tube 11. The front portion of the bicycle 100 is provided with a handle stem 8, a handle 7 fixed to an upper portion of the handle stem 8, a front fork 19 fixed to a lower portion of the handle stem 8, and a front wheel 9 supported at a lower end of the front fork 19. The handle stem 8 is supported by a head pipe 17a at a front end of a frame 17. The shape of the frame 17 is not limited to the example shown in FIG. 1, and may be changed as appropriate.

The bicycle 100 includes a drive unit 20 (see FIG. 1). The drive unit 20 includes an electric motor 21 (see FIG. 2) that outputs assist torque for assisting the rider to drive the rear wheel 6 and a decelerator 25 (see FIG. 2). The electric motor 21 is driven by electric power supplied from the battery 22. The battery 22 may be disposed on the rear side of the seat tube 11, for example, and the drive unit 20 may be disposed on the rear side of the crankshaft 2. The positions of the electric motor 21 and the battery 22 are not limited to the example of the bicycle 100, and may be changed as appropriate.

As shown in FIG. 2, the force applied to the crankshaft 2 through the pedals 2a is transmitted to a resultant transmission mechanism 24 through a one-way clutch 23. The assist torque that is output from the electric motor 21 is transmitted to the resultant transmission mechanism 24 through the decelerator 25 and a one-way clutch 26.

The resultant transmission mechanism 24 includes a shaft, a rotating member provided on the shaft, and a chain 5 (see FIG. 1), for example, and combines the force applied to the crankshaft 2 and the torque that is output from the electric motor 21. In an example of the resultant transmission mechanism 24, two forces (torque) are both entered in a common shaft or a common rotating member to be combined. The force applied to the crankshaft 2 and the torque that is output from the electric motor 21 may be entered in the chain 5 and combined. As shown in FIG. 2, the power combined by the resultant transmission mechanism 24 may be transmitted to the rear wheel 6 through a transmission mechanism 27 and a one-way clutch 28. The transmission mechanism 27 can be shifted by an operation of an operation member (e.g., lever) provided on the handle 7, for example.

The bicycle 100 has a pedaling force sensor 41 (see FIG. 2) for detecting a pedaling force applied to the pedals 2a by the rider. The pedaling force sensor 41 may be a torque sensor that outputs a signal corresponding to the torque generated in the crankshaft 2, for example. In the following, the torque detected by the pedaling force sensor 41 is simply referred to as “pedaling force”.

The bicycle 100 includes a crank rotation sensor 45 that outputs a signal in accordance with a change in the angular position of the crankshaft 2. The crank rotation sensor 45 generates a pulse signal every unit angle change of the crankshaft 2 (e.g., every 1 degree change), for example. The control device 30 calculates an amount of change in the angular position of the crankshaft 2 and a rotation speed of the crankshaft 2 based on the signal from the crank rotation sensor 45. A sensor capable of detecting an absolute angle (angular position) of the crankshaft 2 may be used as the crank rotation sensor 45.

The bicycle 100 includes a motor rotation sensor (encoder) 42 that outputs a signal corresponding to the rotation of the electric motor 21 and a wheel rotation sensor 43 that outputs a signal corresponding to the rotation of the wheels. The control device 30 calculates a rotation speed of the electric motor 21 based on the output of the motor rotation sensor 42, and calculates a vehicle speed based on the output of the wheel rotation sensor 43. The wheel rotation sensor 43 may be attached to the front wheel 9 or the rear wheel 6.

As shown in FIG. 2, the bicycle 100 includes an operation input device 58. The operation input device 58 includes an operation member operable by the rider (e.g., button, lever), and inputs a signal corresponding to such an operation to the control device 30. The rider can select a control mode of the electric motor 21 through the operation input device 58, for example. A touch sensor that detects a position of a finger of the rider touching a display device (not shown) may be used as the operation input device 58.

### [Control Device]

The control device 30 includes one or more memories that hold programs and maps related to control of the electric motor 21, and one or more microprocessors that execute the programs. The control device 30 controls the electric motor 21 based on the output of the pedaling force sensor 41.

### [Multiple Control Modes]

The control device 30 has multiple control modes having different assist ratios as control modes of the electric motor 21. For example, the control device 30 has three control modes (hereinafter, these modes are referred to as “strong mode”, “standard mode”, and “eco mode”). The number of control modes may be less than three or more than three.

The memory of the control device 30 may store one or more maps (hereinafter referred to as “assist ratio maps”) that define the assist ratio. For example, the assist ratio maps may respectively correspond to the control modes. For example, if three control modes (strong mode, standard mode, eco mode) are defined, the three assist ratios may be strong mode>standard mode>eco mode. The assist ratio may be determined according to the vehicle speed, for example. When the bicycle 100 is travelling, the control device 30 may refer to the assist ratio map corresponding to the currently selected control mode and calculate the assist ratio corresponding to the vehicle speed calculated based on the output of the wheel rotation sensor 43.

An arithmetic expression may be used to calculate the assist ratio. In this case, the arithmetic expressions may be respectively provided for the control modes, and may define a relationship between the assist ratio and the vehicle speed. In another example of the calculation of the assist ratio, the assist ratio map and the arithmetic expression may both be used. For example, an assist ratio map commonly used in multiple control modes may be defined. For example, in the standard mode, a value obtained from the common assist ratio map is used as the assist ratio, while in the eco mode and the strong mode, a value obtained by correcting the value obtained from the common assist ratio map may be used as the assist ratio.

### [Functions of Control Device]

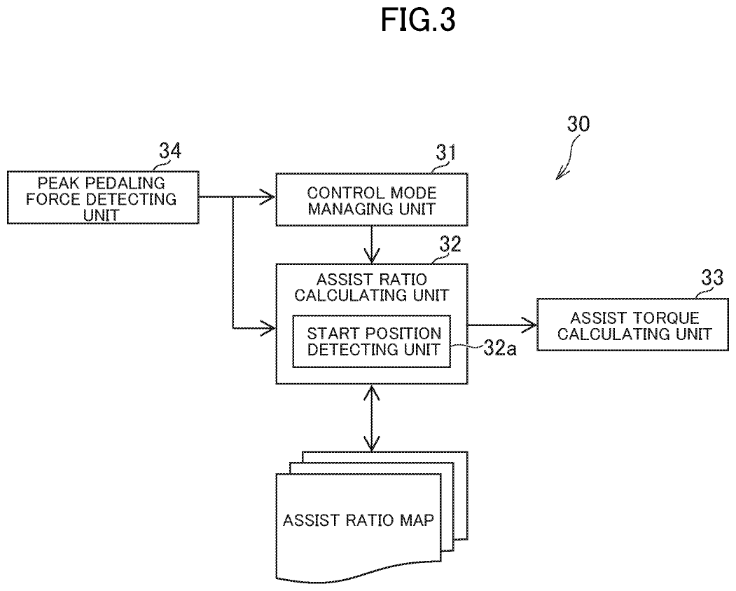

FIG. 3 is a block diagram showing functions of the control device 30. The control device 30 includes, as the functions, a control mode managing unit 31, an assist ratio calculating unit 32, an assist torque calculating unit 33, and a peak pedaling force detecting unit 34. These units are implemented when the microprocessor constituting the control device 30 executes programs stored in the memory.

### [Control Mode Managing Unit]

The control mode managing unit 31 changes the control mode in accordance with a driving state of the bicycle 100 and an instruction from the rider. When the control mode is changed, the assist ratio map and the calculation formula used for calculating the assist ratio are changed.

The control mode managing unit 31 determines whether the condition for changing the control mode defined in advance is satisfied. When the change condition is satisfied, the control mode managing unit 31 automatically changes the control mode without the operation of the rider. For example, the control mode managing unit 31 determines whether the pedaling force calculated based on the output of the pedaling force sensor 41 satisfies the change condition.

For example, the control mode managing unit 31 determines whether the peak pedaling force exceeds a threshold value in a predetermined number (one or more times) of pedaling motions of the pedals 2a. The peak pedaling force is the maximum of pedaling force in a single pedaling motion. When the one or more peak pedaling forces exceed the threshold value, the control mode managing unit 31 changes the control mode to the up side (“change to the up side” means a change to the control mode in which a higher assist ratio is calculated). Further, the control mode managing unit 31 determines whether the peak pedaling force is below the threshold value in a predetermined number (one or more times) of pedaling motions of the pedals 2a. When the one or more peak pedaling forces are below the threshold value, the control mode managing unit 31 changes the control mode to the down side (“change to the down side” means a change to the control mode in which a lower assist ratio is calculated). The peak pedaling force is detected by processing of the peak pedaling force detecting unit 34 to be described later.

The control mode managing unit 31 may calculate average pedaling force in a predetermined number (one or more times) of pedaling motions of the pedals 2a. When the average exceeds the threshold value, the control mode managing unit 31 may change the control mode to the up side, or when the average is below the threshold value, the control mode managing unit 31 may change the control mode to the down side.

These threshold values may be determined for each control mode related to the changes. For example, different threshold values may be set for the change from the eco mode to the standard mode and the change from the standard mode to the strong mode.

The bicycle 100 includes the operation input device 58 (see FIG. 2). The rider can input a mode change instruction to the control device 30 through the operation input device 58. One of the mode change conditions may be the input of such a mode change instruction from the operation input device 58 to the control device 30.

### [Assist Ratio Calculating Unit]

The assist ratio calculating unit 32 uses an assist ratio map or an arithmetic expression corresponding to the currently selected control mode to calculate an assist ratio corresponding to the vehicle speed detected by the wheel rotation sensor 43.

When the condition for changing the control mode is satisfied, the assist ratio calculating unit 32 gradually changes the assist ratio from the assist ratio defined in the control mode before the change to the assist ratio defined in the changed control mode. The assist ratio calculating unit 32 starts changing the assist ratio when the angular position of the crankshaft 2 reaches a predetermined position.

In the following, the angular position of the crankshaft 2 is referred to as a “crank angular position”. The control mode before the change is referred to as a “first control mode”, and the assist ratio calculated by the first control mode is referred to as a “first assist ratio”. Further, the changed control mode is referred to as a “second control mode”, and the assist ratio calculated by the second control mode is referred to as a “second assist ratio.” An angular position at which the change of the assist ratio starts is referred to as a “change start position”, and an angular position at which the change of the assist ratio ends is referred to as a “change end position.”

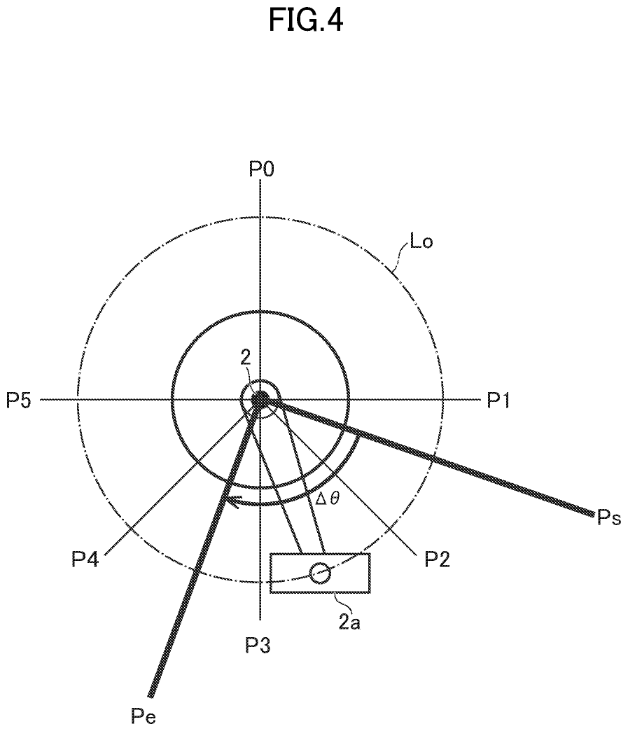

FIG. 4 is a diagram for showing the change start position and the change end position, and indicates a trajectory Lo of the crankshaft 2 and the pedal 2a.

The change start position Ps is defined between an angular position P1 obtained by adding 90 degrees to the angular position corresponding to the uppermost point P0 of the trajectory Lo of the pedal 2a and an angular position P2 obtained by adding 135 degrees to the angular position corresponding to the uppermost point P0. The change end position Pe is obtained by adding at least 45 degrees to the change start position Ps. The assist ratio calculating unit 32 starts changing the assist ratio when the crank angular position reaches the change start position Ps. The assist ratio calculating unit 32 gradually changes the assist ratio so that the assist ratio reaches the second assist ratio when the crank angular position reaches the change end position Pe.

Such processing of the assist ratio calculating unit 32 can reduce the impact on the ride quality caused by the change in the assist ratio associated with the change in the control mode. Generally, the pedaling force is maximized when the pedal 2a is located at a position rotated by 90 degrees from the uppermost point P0 (in FIG. 4, angular position P1). The pedaling force is gradually weakened when the pedal 2a passes this angular position P1. As such, a relatively weak pedaling force is input to the pedal 2a between the change start position Ps and the change end position Pe described above. In other words, the assist ratio changes in accordance with the period in which the pedaling force is weakened. As such, the rider is less likely to feel the change in the assist ratio, and thus the ride quality can be further improved.

This is particularly effective when the control mode is changed to the up side. Between the change start position Ps and the change end position Pe described above, the pedaling force acting on the pedal 2a is gradually weakened, while the assist ratio is gradually increased when the control mode is changed to the up side. As such, a decrease in the assist torque or a decrease in the acceleration of the bicycle 100 due to the decrease in the pedaling force can be compensated for by the increase in the assist ratio. This can further improve the ride quality.

An angular difference Δθ (see FIG. 4) between the change start position Ps and the change end position Pe is preferably 60 degrees or more. This can more effectively prevent a sudden change in the assist torque caused by changing the control modes.

The angular difference Δθ (see FIG. 4) between the change start position Ps and the change end position Pe may be 135 degrees or less. This can prevent an excessively large amount of time required for changing the assist ratio from the first assist ratio to the second assist ratio. Preferably, the angular difference Δθ may be 90 degrees or less. This can optimize the change rate of the assist ratio. The angular differential between the change start position Ps and the change end position Pe may be substantially 70 degrees.

The change end position Pe may be a position obtained by adding an angle of 360 degrees or less to an angular position corresponding to the uppermost point P0. In this configuration, the changing of the assist ratio is ended before the pedal 2a reaches the uppermost point P0, and this prevents the delay in starting the travel at the second assist ratio.

The change end position Pe may be an angular position obtained by adding an angle of 270 degrees or less to the uppermost point P0. This effectively prevents excessive delay in the start of the travel at the assist ratio according to the changed control mode.

The change end position may be obtained by adding an angle of 225 degrees or less to an angular position corresponding to the uppermost point P0. This further effectively prevents the delay in the start of the travel at the second assist ratio.

The change end position Pe may be between an angular position P2 obtained by adding 135 degrees to the angular position corresponding to the uppermost point P0 and an angular position P4 obtained by adding 225 degrees to the angular position corresponding to the uppermost point P0. That is, the change end position Pe may be close to the angular position P3 corresponding to the lowermost point of the pedal 2a. When the pedal 2a is in such an angular position, the pedaling force is weakened. In other words, changing the assist ratio is completed when the pedaling force is weakened. As such, the rider is less likely to feel the change in the assist ratio, and thus the ride quality can be further improved.

The assist ratio calculating unit 32 may gradually change the assist ratio only when the control mode is changed to the up side. When the control mode is changed to the down side, the processing of the assist ratio calculating unit 32 described above may not be executed.

In a case where the control mode is changed to the down side, the assist ratio may be immediately changed when the crank angular position reaches a predetermined position. The predetermined position in this case may be close to the angular position P3 corresponding to the lowermost point of the pedal 2a, for example.

### [Calculation of Assist Ratio]

When the crank angular position is between the change start position Ps and the change end position Pe, the assist ratio calculating unit 32 calculates an assist ratio such that the assist ratio gradually approaches the second assist ratio from the first assist ratio. The assist ratio calculating unit 32 calculates an assist ratio based on the crank angular position, for example. More specifically, the assist ratio calculating unit 32 calculates an assist ratio based on the crank angular position, a difference between the first assist ratio and the second assist ratio, and an angle difference Δθ between the change start position Ps and the change end position Pe.

The assist ratio calculating unit 32 calculates a rate of change in the assist ratio, for example, based on a difference between the first assist ratio R1 and the second assist ratio R2 and an angular difference Δθ between the change start position Ps and the change end position Pe. The rate of change is an amount of change in the assist ratio corresponding to a unit change (e.g., 1 degree) in the angular position of the crankshaft 2. The rate of change can be calculated by Equation 1-1, for example.

$$r = ( R 2 - R 1 ) / Δθ \qquad Equation 1 - 1$$

r: rate of change in assist ratio
R1: first assist ratio
R2: second assist ratio
Δθ: angular difference between the change start position Ps and the change end position Pe

The assist ratio calculating unit 32 calculates an assist ratio based on the amount of change in the angular position of the crankshaft 2 from the change start position Ps (i.e., the difference between the change start position Ps and the current crank angular position) and the rate of change. For example, the assist ratio calculating unit 32 calculates an assist ratio by using the following Equation 1-2.

$$Rx = r \times θ + R 1 \qquad Equation 1 - 2$$

Rx: assist ratio at a position between the change start position
Ps and the change end position Pe
r: rate of change in assist ratio
θ: current angular position of the crankshaft 2 when the change start position Ps is 0 degrees (hereinafter, change progress angle)

The assist ratio calculating unit 32 calculates a crank angular position at a predetermined cycle based on the output of the crank rotation sensor 45. The assist ratio calculating unit 32 starts to count “change progress angle θ” used in Equation 1-2 from the time when the crank angular position reaches the change start position Ps.

According to Equations 1-1 and 1-2, as the change progress angle θ approaches the angle difference Δθ, the assist ratio Rx gradually approaches the second assist ratio R2. When the change progress angle θ reaches the angle difference Δθ, that is, when the current crank angular position reaches the predetermined change end position Pe, the assist ratio Rx reaches the second assist ratio R2. In other words, the angular position at which the assist ratio Rx reaches the second assist ratio R2 can be fixed regardless of the assist ratios R1 and R2.

The assist ratios R1 and R2 may correspond to the vehicle speed calculated immediately before the start of changing the assist ratio. That is, the assist ratio calculating unit 32 uses the assist ratio map or the arithmetic expression corresponding to the first control mode to calculate, as the first assist ratio R1, the assist ratio corresponding to the vehicle speed calculated immediately before the start of changing the assist ratio. Further, the assist ratio calculating unit 32 uses the assist ratio map or the arithmetic expression corresponding to the second control mode to calculate, as the second assist ratio R2, the assist ratio corresponding to the vehicle speed calculated immediately before the start of changing the assist ratio.

The processing of the assist ratio calculating unit 32 is not limited to the examples using the Equations 1-1 and 1-2.

For example, the assist ratio calculating unit 32 may calculate the assist ratio based on the change progress angle θ of the crankshaft 2 and a predetermined rate of change in the assist ratio (an amount of change in the crank angular position per unit change (e.g., 1 degree)).

In this case, the rate of change in the assist ratio may be defined in advance such that the assist ratio reaches the second assist ratio before the crank angular position reaches the angular position P5 (the position obtained by adding 270 degrees to point P0) the uppermost described above. Alternatively, the rate of change in the assist ratio may be determined in advance such that the change end position Pe is eventually between the angular position P2 (see FIG. 4) and the angular position P4 (see FIG. 4).

As yet another example, the assist ratio calculating unit 32 may calculate the assist ratio based on the elapsed time since the start of changing the assist ratio (hereinafter referred to as change progress time). For example, the assist ratio calculating unit 32 may calculate the assist ratio based on the change progress time and the change rate of the assist ratio (an amount of change in the assist ratio per unit time).

In this case, the change rate of the assist ratio may be defined in advance such that the assist ratio reaches the second assist ratio before the crank angular position reaches the angular position P5 (the position obtained by adding 270 degrees to the uppermost point P0) described above. Alternatively, the change rate of the assist ratio may be determined in advance such that the change end position Pe is eventually between the angular position P2 (see FIG. 4) and the angular position P4 (see FIG. 4).

As yet another example, the assist ratio calculating unit 32 may calculate the change rate of the assist ratio based on the difference between the first assist ratio R1 and the second assist ratio R2 and the time required for changing the crank angular position from the change start position Ps to the change end position Pe. The assist ratio calculating unit 32 may calculate the assist ratio based on the change progress time and the change rate.

### [Start Position Determining Unit and Peak Pedaling Force Detecting Unit]

The assist ratio calculating unit 32 includes a start position detecting unit 32a. The start position detecting unit 32a detects that the crank angular position has reached the change start position Ps. The start position detecting unit 32a detects that the crank angular position has reached the change start position Ps based on the output of the pedaling force sensor 41 and the output of the crank rotation sensor 45, for example.

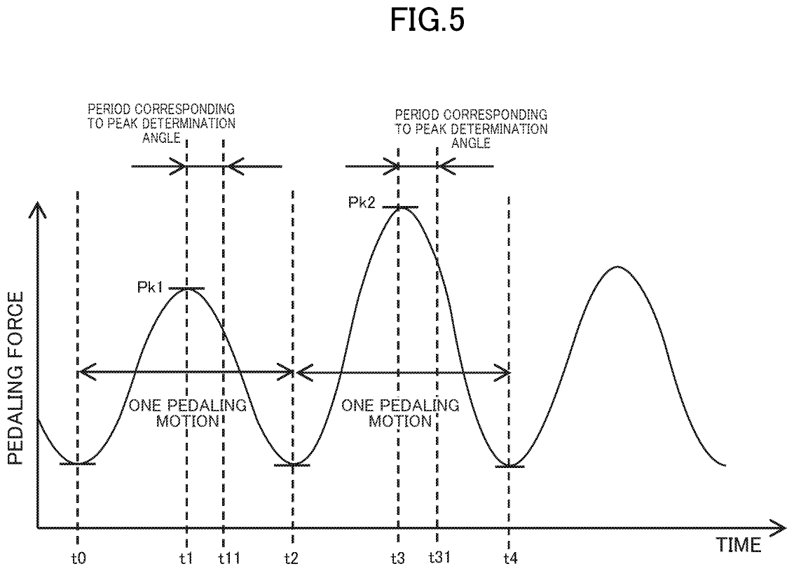

FIG. 5 is a time chart showing an example of the processing performed by the start position detecting unit 32a and the peak pedaling force detecting unit 34. The vertical axis in FIG. 5 represents the pedaling force detected based on the output of the pedaling force sensor 41. As shown in FIG. 5, the pedaling force varies periodically. For example, one of the pedals 2a (e.g., right pedal 2a) is estimated to be in a horizontal position (angular position P1, see FIG. 4) at t1 when the peak pedaling force Pk1 is obtained. One of the pedals 2a is estimated to be in the lowest point (angular position P3, see FIG. 4) at t2 when the pedaling force is smallest. The other one of the pedals 2a (e.g., left pedal 2a) is estimated to be in a horizontal position (angular position P1, see FIG. 4) at t3 when the next peak pedaling force Pk2 is obtained, and is estimated to be in the lowest point (angular position P3, see FIG. 4) at t4 when the pedaling force is smallest.

The peak pedaling force detecting unit 34 searches for the maximum pedaling force (i.e., peak pedaling force) in “one pedaling motion”. The “one pedaling motion” corresponds to a movement from the uppermost point P0 to the lowermost point of each pedal 2a, for example. In the above example, the “one pedaling motion” of the right pedal 2a corresponds to the period from to, at which the pedaling force is minimized, to t2, at which the pedaling force is minimized next time. The “one pedaling motion” of the left pedal 2a corresponds to the period from t2, at which the pedaling force is minimized, to t4, at which the pedaling force is minimized next time.

The peak pedaling force detecting unit 34 detects the pedaling force at a sampling cycle that is sufficiently shorter than the time required for one pedaling motion based on the output of the pedaling force sensor 41, for example. The candidates for peak pedaling force are recorded in the memory. The peak pedaling force detecting unit 34 compares the candidate for the peak pedaling force recorded in the memory with the newly detected pedaling force. If the newly detected pedaling force is larger than the candidate recorded in the memory, the peak pedaling force detecting unit 34 rewrites the candidate of the peak pedaling force recorded in the memory to the newly detected pedaling force. In contrast, if the newly detected pedaling force is smaller than the candidate of the peak pedaling force recorded in the memory, the peak pedaling force detecting unit 34 maintains the candidate of the peak pedaling force recorded in the memory.

If the pedaling force recorded in the memory is not changed while the crankshaft 2 rotates by a predetermined angle (the period of t1 to t11 and the period of t3 to t31 in FIG. 5), the peak pedaling force detecting unit 34 determines the candidate recorded in the memory as the peak pedaling force. In the following, such a predetermined angle is referred to as a “peak determination angle” (see FIG. 5). For example, the peak determination angle is 20 degrees, but may be smaller than 20 degrees (e.g., 10 degrees) or larger than 20 degrees (e.g., 30 degrees).

The start position detecting unit 32a sets an angular position at the time when the crankshaft 2 rotates by a predetermined angle from the time when the peak pedaling force is entered in the pedal 2a (time point t1 in FIG. 5) as a change start position Ps. In the following, such a predetermined angle is referred to as a “start delay angle”. The start delay angle may be the same as the peak determination angle (e.g., 20 degrees) described above. In this case, it is determined that the change start position Ps is reached at the same time when the crank angular position reaches the peak determination angle and the peak pedaling force is determined. Alternatively, the start delay angle may be greater than the peak determination angle. For example, the change start detecting unit 32a may set, as a change start position Ps, an angular position at the time point when the crankshaft 2 rotates by the start delay angle (e.g., 30 degrees) larger than the peak determination angle from the time (t1 in FIG. 5) when the peak pedaling force is entered to the pedal 2a.

The crank rotation sensor 45 may not generate a pulse signal for each unit angle change (e.g., every 1 degree change) of the crankshaft 2, but may output a signal corresponding to an absolute angle. In this case, the change start position Ps may be detected based on the output of the sensor. In this case, the peak pedaling force may not be used in detecting the change start position Ps.

### [Assist Torque Calculating Unit]

The assist torque calculating unit 33 calculates an assist torque based on the assist ratio calculated by the assist ratio calculating unit 32 and the pedaling force detected by the pedaling force sensor 41. Specifically, the assist torque calculating unit 33 calculates a result obtained by multiplying the assist ratio by the pedaling force as the assist torque. The assist torque calculating unit 33 may calculate, as the assist torque, a result obtained by multiplying the average pedaling force in the predetermined number of pedaling motions by the assist ratio. In this regard, when counting pedaling motions, the movement of the pedal 2a from the uppermost point P0 to the lowermost point may be counted as one pedaling motion. Alternatively, the assist torque calculating unit 33 may calculate, as the assist torque, a result obtained by multiplying the average pedaling force at the predetermined time by the assist ratio. As yet another example, the assist torque calculating unit 33 may not use such an average but may calculate the result, which is obtained by multiplying the assist ratio calculated by the assist ratio calculating unit 32 by the current pedaling force, as the assist torque. The control device 30 outputs a command value corresponding to the assist torque to the motor drive device 39.

### [Flow of Processing]

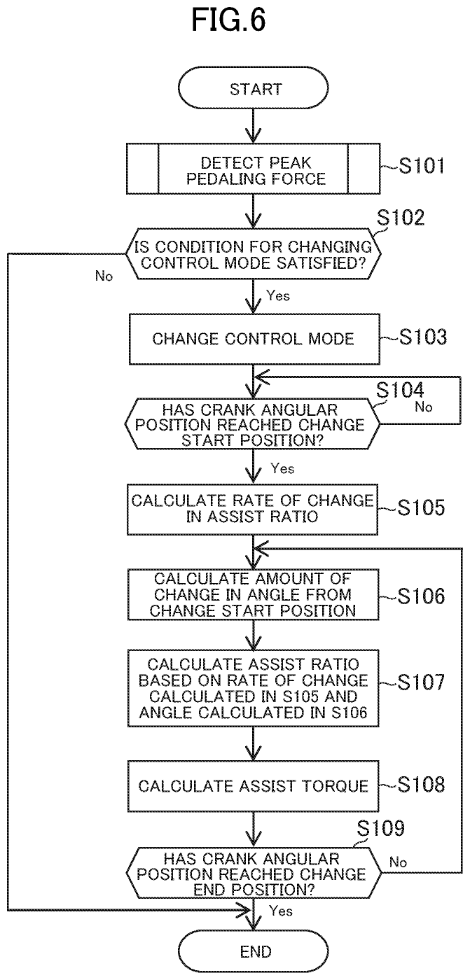

An example of processing executed by the control device 30 will be described. FIG. 6 is a flow chart showing the processing related to changing the control modes executed by the control device 30. The processing shown in FIG. 6 is repeatedly executed while the bicycle 100 is traveling.

The peak pedaling force detecting unit 34 detects the peak pedaling force based on the output of the pedaling force sensor 41 (S101). As described with reference to FIG. 5, the peak pedaling force is the maximum of the pedaling force in one pedaling motion. The control mode managing unit 31 determines whether the condition for changing the control mode is satisfied (S102). For example, the control mode managing unit 31 determines whether the peak pedaling force detected in S101 exceeds the threshold value.

If the condition for changing the control mode is not satisfied (“No” in S102), the control device 30 terminates the current processing. If the condition for changing the control mode is not satisfied in the determination of S102, the assist ratio calculating unit 32 and the assist torque calculating unit 33 calculate an assist ratio and an assist torque in the current control mode. For example, the assist ratio calculating unit 32 uses the assist ratio map and the arithmetic expression that are defined for the current control mode to calculate an assist ratio. The assist torque calculating unit 33 calculates an assist torque based on the calculated assist ratio and the pedaling force detected by the pedaling force sensor 41. The execution cycle of the calculation processing of the assist ratio etc. may be the same as or different from the execution cycle of the processing shown in FIG. 6.

If the condition for changing the control mode is satisfied (“Yes” in S102), the control mode managing unit 31 changes the control mode (S103). The control mode managing unit 31 may record the changed control mode in the memory of the control device 30 as the newly selected control mode.

The start position detecting unit 32a then determines whether the crank angular position has reached the change start position Ps (S104). For example, the start position detecting unit 32a determines whether the crankshaft 2 has rotated by the start delay angle from the angular position at which the peak pedaling force is entered in the pedal 2a (the angular position at t1 in FIG. 6). The start position detecting unit 32a repeatedly executes the determination processing of S104 at a predetermined cycle until the crank angular position reaches the change start position Ps.

When the crank angular position reaches the change start position Ps (“Yes” in S104), the assist ratio calculating unit 32 calculates the rate of change in the assist ratio (S105). The rate of change can be calculated using the Equation 1-1 described above, for example.

The assist ratio calculating unit 32 calculates an amount of change in the crank angular position from the change start position Ps, that is, a difference between the change start position Ps and the current crank angular position (S106). The assist ratio calculating unit 32 then calculates an assist ratio according to the amount of change in the crank angular position calculated in S106 and the rate of change in the assist ratio calculated in S105 (S107). For example, the equation described above (Equation 1-2) may be used for this calculation.

The assist torque calculating unit 33 calculates an assist torque based on the calculated assist ratio and the pedaling force detected by the pedaling force sensor 41 (S108). As described above, in S108, the assist torque calculating unit 33 may use the average pedaling force in the predetermined number of pedaling motions, the average pedaling force in the predetermined period, and the current pedaling force that is not such an average, for example. The control device 30 outputs a command value corresponding to the calculated assist torque to the motor drive device 39.

The assist ratio calculation unit 32 determines whether the crank angular position has reached the change end position Pe (S109). If the crank angular position has not yet reached the change end position Pe (“No” in S109), the control device 30 returns to S106 and executes the subsequent processing again. On the other hand, if the crank angular position reaches the change end position Pe (“Yes” in S109), the control device 30 terminates the present processing.

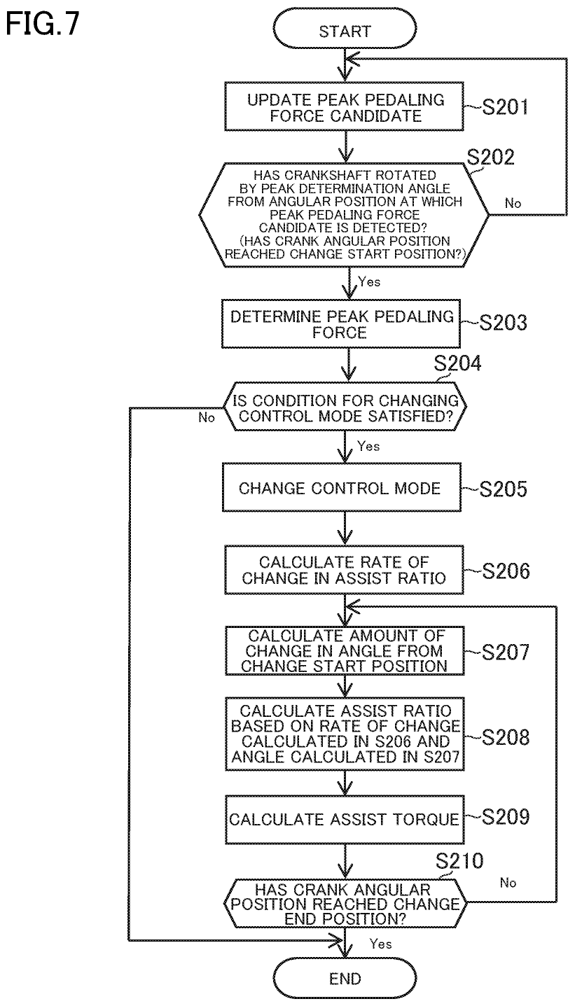

The start position detecting unit 32a sets an angular position at the time when the crankshaft 2 rotates by the start delay angle from the time when the peak pedaling force is entered in the pedal 2a (t1 in FIG. 5) as a change start position Ps. As described above, the start delay angle may be the same as the peak determination angle. When such processing is executed, the crankshaft 2 has reached the change start position Ps at the time when the peak pedaling force is detected in S101, and thus the processing of S104 may not be executed. FIG. 7 is a flow chart showing an example of processing executed by the control device 30 in such a case. The processing shown in FIG. 7 is repeatedly executed while the bicycle 100 is traveling.

For example, the control device 30 (peak pedaling force detecting unit 34) detects the pedaling force at a predetermined sampling cycle based on the output of the pedaling force sensor 41 and updates the candidates of the peak pedaling force recorded in the memory (S201). Specifically, the control device 30 compares the candidate of the peak pedaling force recorded in the memory with the newly detected pedaling force. If the newly detected pedaling force is larger than the candidate recorded in the memory, the control device 30 rewrites the candidate of the peak pedaling force recorded in the memory to the newly detected pedaling force. In contrast, if the newly detected pedaling force is smaller than the candidate of the peak pedaling force recorded in the memory, the control device 30 maintains the candidate of the peak pedaling force recorded in the memory.

The control device 30 determines whether the crankshaft 2 has rotated by the peak determination angle from the angular position at which the most recent peak pedaling force candidate recorded in the memory is detected (S202). As described above, in the processing described in FIG. 7, the peak determination angle and the start delay angle are the same. As such, in other words, the determination in S202 is to determine whether the crank angular position has reached the change start position Ps.

If the crankshaft 2 has not yet reached the peak determination angle (“No” in S202), the control device 30 returns to S201. On the other hand, if the rotation of the crankshaft 2 has reached the peak determination angle (“Yes” in S202), the control device 30 (peak pedaling force detecting unit 34) determines the most recent candidate recorded in the memory as the peak pedaling force (S203). The start delay angle and the peak determination angle are the same in this case, and thus the crank angular position has reached the change start position Ps at the time when the peak pedaling force is determined.

The subsequent processing may be executed in the same manner as the example of FIG. 6. That is, the control mode managing unit 31 determines whether the condition for changing the control mode is satisfied (S204). If the condition for changing the control mode is not satisfied (“No” in S204), the control device 30 terminates the current processing. If the condition for changing the control mode is not satisfied, the assist ratio calculating unit 32 and the assist torque calculating unit 33 calculate an assist ratio and an assist torque in the current control mode.

If the condition for changing the control mode is satisfied (“Yes” in S204), the control mode managing unit 31 changes the control mode (S205). Further, the assist ratio calculating unit 32 calculates the rate of change in the assist ratio (S206). The rate of change can be calculated using the Equation 1-1 described above, for example. The assist ratio calculating unit 32 calculates an amount of change in the crank angular position from the change start position Ps, that is, a difference between the change start position Ps and the current crank angular position (S207). The assist ratio calculating unit 32 then calculates an assist ratio according to the amount of change in the crank angular position calculated in S207 and the rate of change in the assist ratio calculated in S206 (S208). The equation described above (Equation 1-2) may be used for this calculation, for example.

The assist torque calculating unit 33 calculates an assist torque based on the calculated assist ratio and the pedaling force detected by the pedaling force sensor 41 (S209). The assist ratio calculation unit 32 determines whether the crank angular position has reached the change end position Pe (S210). If the crank angular position has not yet reached the change end position Pe (“No” in S210), the control device 30 returns to S207 and executes the subsequent processing again. On the other hand, if the crank angular position reaches the change end position Pe (“Yes” in S210), the control device 30 terminates the present processing.

### [Time Chart]

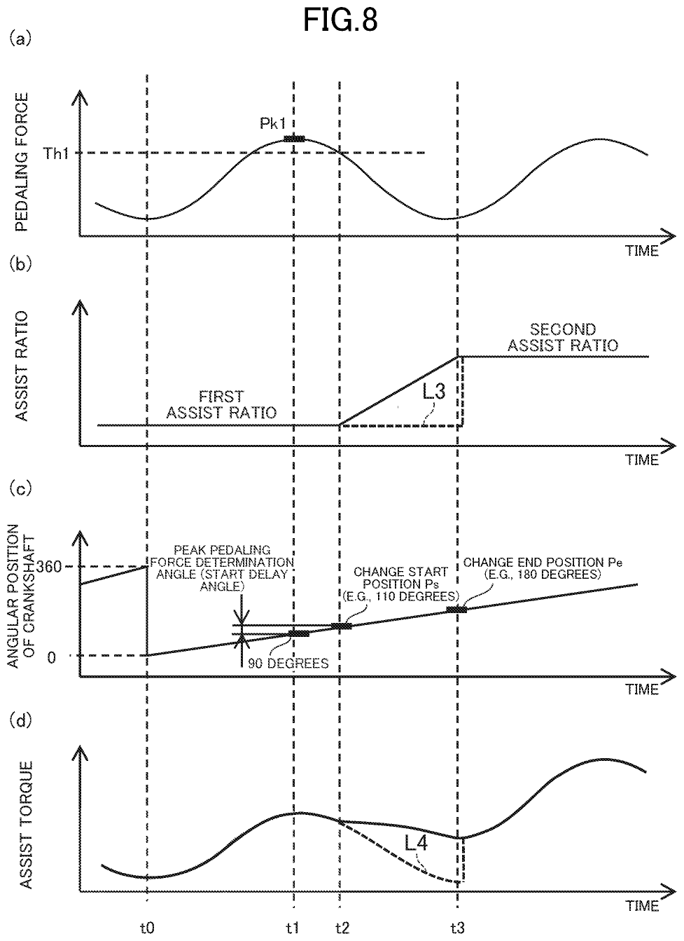

FIG. 8 is a time chart showing an example of a result of processing performed by the control device 30. FIG. 8(a) shows a change in the pedaling force. FIG. 8(b) shows a change in the assist ratio. FIG. 8(c) shows a change in the crank angular position. As shown in FIG. 8(a) and FIG. 8(c), the crank angular position at which the pedaling force is minimized is set to 0 degrees. FIG. 8(d) shows a change in the assist torque. In FIG. 8, a case where the control mode is changed to the up side will be described.

At the time point t1, the peak pedaling force exceeding a threshold value Th1 that defines the condition for changing the control mode is entered in the pedal 2a. As described above, the peak pedaling force detecting unit 34 compares the candidate of the peak pedaling force detected in the past with the newly detected peak pedaling force. If the newly detected peak pedaling force is greater than the candidate of the peak pedaling force, the candidate of the peak pedaling force is rewritten to the newly detected peak pedaling force. If the candidate of the peak pedaling force does not change while the crankshaft 2 rotates by a predetermined angle (peak determination angle, e.g., 20 degrees), the candidate is determined as the peak pedaling force. In the embodiment shown in FIG. 8(a), the peak pedaling force Pk1 is determined at the time point t2.

The control mode managing unit 31 determines whether the peak pedaling force Pk1 exceeds the threshold Th1 at the time point t2. The peak pedaling force Pk1 shown in FIG. 8(a) is greater than the threshold Th1, and thus the control mode managing unit 31 changes the control mode to the up side (e.g., from the eco mode to the normal mode). In the example shown in FIG. 8, the start delay angle is the same as the peak determination angle. As such, the crank angular position at the time point t2 is the change start position Ps. As such, the assist ratio calculating unit 32 gradually increases the assist ratio from the first assist ratio (assist ratio in the control mode before the change) to the second assist ratio (assist ratio in the control mode after the change) starting from the time point t2.

The start delay angle may be greater than the peak determination angle. In this case, the assist ratio calculating unit 32 starts to increase the assist ratio from the first assist ratio toward the second assist ratio after the time point t2.

At the time point t3, the crank angular position reaches the change end position Pe (FIG. 8(c)), and the assist ratio reaches the second assist ratio (FIG. 8(b)). During the period from the change start position Ps to the change end position Pe, the pedaling force decreases as shown in FIG. 8(a), while the assist ratio increases as shown in FIG. 8(b). In FIG. 8(d), the result obtained by multiplying the current pedaling force (not the average) by the assist ratio is calculated as the assist torque. As such, in the period up to the time point t2, the assist torque varies in accordance with the pedaling force. On the other hand, during the period from t2 to t3, the assist ratio gradually increases, and thus the change in the assist torque can be reduced as shown in FIG. 8(d).

The broken line L3 shown in FIG. 8(b) indicates an example in which the assist ratio is fixed at the first assist ratio until the time point t3 and is instantaneously increased to the second assist ratio at the time point t3 (e.g., at the time point when the crank angular position becomes 180 degrees). In this case, as indicated by the broken line L4 in FIG. 8(d), the assist torque is also decreased in accordance with the reduced pedaling force until the time point t3 and is also rapidly increased in accordance with the instantaneous increase in the assist ratio at the time point t3. As indicated in the comparison between the broken lines L3 and L4, the processing of the control device 30 can prevent a sudden change in the assist torque when the condition for changing the control mode is satisfied.

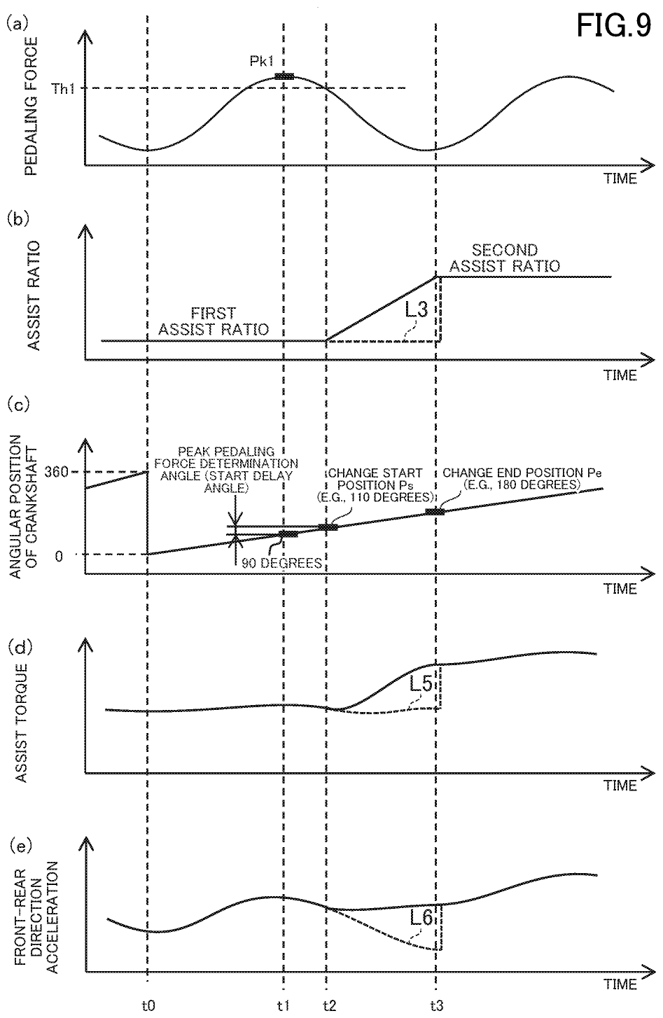

FIG. 9 is a time chart showing another example of the result of the processing of the control device 30. FIGS. 9(a), 9(b), 9(c), and 9(d) show changes in pedaling force, assist ratio, crank angular position, and assist torque, similarly to FIG. 8. FIG. 9(e) shows a change in acceleration of the bicycle 100 in the front-rear direction. The acceleration of the bicycle 100 corresponds to the sum of the pedaling force shown in FIG. 9(a) and the assist torque shown in FIG. 9(d). Similarly to FIG. 8, FIG. 9 also describes a case where the control mode is changed to the up side.

Unlike FIG. 8, FIG. 9 shows an example in which an assist torque is calculated based on the average pedaling force in a predetermined number of pedaling motions (or the average pedaling force at a predetermined time) and the assist ratio. The changes in the pedaling force shown in FIGS. 9(a), 9(b), and 9(c) are the same as those in FIG. 8, and thus the description thereof will be omitted here.

In FIG. 9, an assist torque is calculated based on the average pedaling force and the assist ratio. As such, as shown in FIG. 9(d), the assist torque does not change as much as the pedaling force shown in FIG. 9(a) during the period up to the time point t2. The acceleration of the bicycle 100 corresponds to the sum of the pedaling force and the assist torque, and thus, as shown in FIG. 9(e), the acceleration of the bicycle 100 changes in accordance with the pedaling force during the period up to the time point t2.

As shown in FIG. 9(b), the assist ratio gradually increases from the time point t2. The averaging pedaling force does not change greatly, and thus the assist torque also gradually increases in accordance with the assist ratio during the period from t2 to t3. On the other hand, as shown in FIG. 9(a), the pedaling force gradually decreases in this period (the angular range from the change start position Ps to the change end position Pe). As such, the increase in the assist torque compensates for the decrease in the pedaling force, and this prevents the change in the acceleration of the bicycle 100. This improves the ride quality of the bicycle 100 when the control mode is changed.

The broken line L5 in FIG. 9(d) and the broken line L6 in FIG. 9(e) indicate the assist torque and the acceleration of the bicycle 100 when the assist ratio is constant until the time point t3 and changes from the first assist ratio to the second assist ratio at the time point t3 as indicated by the broken line L3 in FIG. 9(b). In this case, the average pedaling force is not greatly changed and the assist ratio is constant in the period from t2 to t3, and thus the assist torque does not greatly change as indicated by the broken line L5 in FIG. 9(d). On the other hand, the pedaling force decreases during this period (FIG. 9(a)), and thus the acceleration of the bicycle 100 also decreases accordingly (dashed line L6 in FIG. 9(e)). As shown by the broken line L3 in FIG. 9(b), when the assist ratio changes from the first assist ratio to the second assist ratio at the time point t3, the assist torque rapidly increases (the broken line L5 in FIG. 9(d)), and consequently, the acceleration of the bicycle 100 rapidly increases (the broken line L6 in FIG. 9(e)). This affects the ride quality when the control mode is changed. The processing of the control device 30 proposed in the present disclosure can prevent such a sudden change in acceleration.

### CONCLUSION

(1) The drive system 10 includes a sensor that detects pedaling force acting on a pedal 2a attached to a crankshaft 2, an electric motor 21 that assists a pedaling motion of the pedal 2a, and a control device 30 that controls the electric motor based on an assist ratio according to a control mode and the pedaling force detected by the sensor. The control device 30 includes, as the control mode, a first control mode for controlling the electric motor 21 based on a first assist ratio and a second control mode for controlling the electric motor 21 based on a second assist ratio. When a condition for transitioning from the first control mode to the second control mode is satisfied, the control device 30 starts to change the assist ratio from the first assist ratio to the second assist ratio at a change start position Ps between an angular position P1 obtained by adding 90 degrees to a crank angular position corresponding to an uppermost point P0 of a trajectory Lo of the pedal 2a and an angular position P2 obtained by adding 135 degrees to the crank angular position corresponding to the uppermost point P0. The control device 30 changes the assist ratio such that the assist ratio reaches the second assist ratio at a change end position Pe obtained by adding at least 45 degrees to the change start position Ps.

This drive system 10 gradually changes the assist ratio, and thus can reduce any negative impact on ride quality caused by the change in the assist ratio associated with the change in the control mode. The pedaling force is weakened between the change start position Ps and the change end position Pe. In other words, the assist ratio changes in accordance with the period in which the pedaling force is weakened. As such, the rider is less likely to feel the change in the assist ratio, and thus the ride quality can be further improved.

(2) In the drive system 10 of (1), the angular difference Δθ between the change start position Ps and the change end position Pe may be 135 degrees or less. This can prevent an excessive amount of time required for changing the assist ratio.

(3) In the drive system 10 of (1) or (2), the angular difference Δθ between the change start position Ps and the change end position Pe may be 60 degrees or more. This can more effectively prevent a sudden change in the assist torque caused by changing the control modes.

(4) In the drive system 10 of (1) to (3), the change end position Pe may be between an angular position P0 obtained by adding 135 degrees to the uppermost point P0 and an angular position P4 obtained by adding 225 degrees to the uppermost point P2. When the crankshaft 2 is in such an angular position, the pedaling force is weakened. In other words, changing the assist ratio is completed when the pedaling force is weakened. As such, the rider is less likely to feel the change in the assist ratio, and thus the ride quality can be further improved.

(5) In the drive system 10 of (1) to (4), the change end position Pe may be an angular position obtained by adding an angle equal to or less than 270 degrees to the uppermost point P0. This effectively prevents excessive delay in the start of the travel at the assist ratio according to the changed control mode.

(6) In the drive system 10 of (1) to (5), the change end position Pe may be an angular position obtained by adding an angle equal to or less than 225 degrees to the uppermost point P0. This effectively prevents excessive delay in the start of the travel at the assist ratio (second assist ratio) according to the changed control mode.

(7) In the drive system 10 of (1) to (6), when the crank angular position is between the change start position Ps and the change end position Pe, the control device 30 may calculate the assist ratio such that the assist ratio gradually approaches the second assist ratio from the first assist ratio.

(8) The drive system 10 of (1) to (6) may include a sensor that detects an amount of change in the crank angular position. When the pedal 2a is between the change start position Ps and the change end position Pe, the control device 30 may calculate the assist ratio based on the amount of change in the crank angular position. This enables easily changing the assist ratio between the change start position Ps and the change end position Pe.

(9) In the drive system 10 of (1) to (8), the control device 30 may calculate a rate of change in the assist ratio based on a difference between the first assist ratio and the second assist ratio and an angular difference Δθ between the change start position Ps and the change end position Pe. This easily enables completely changing the assist ratio when the crank angular position reaches the predetermined change end position Pe.

(10) An electric assisted bicycle 100 proposed in the present disclosure includes the drive system 10 according to (1) to (9) and a wheel that receives an assist torque from the electric motor 21.

The drive system proposed in the present disclosure is not limited to the examples described above.

For example, the control device 30 calculates a rate of change in the assist ratio based on a difference between the first assist ratio and the second assist ratio and an angular difference Δθ between the change start position Ps and the change end position Pe. When the condition for changing the control mode is satisfied, the assist ratio may be calculated based on the rate of change and the amount of change in the crank angular position from the position at which changing the assist ratio is started. This processing may be applied to a drive system in which an assist ratio is changed in a range different from the range defined by the change start position Ps (between the angular positions P1 and P2) and the change end position Pe.

What is claimed is:

1. A drive system for an electric assisted bicycle, comprising:
a sensor that detects pedaling force acting on a pedal attached to a crankshaft;
an electric motor that assists a pedaling motion applied to the pedal; and
a control device that controls the electric motor based on an assist ratio according to a control mode and the pedaling force detected by the sensor, wherein
the control device includes, as the control mode, a first control mode for controlling the electric motor based on a first assist ratio and a second control mode for controlling the electric motor based on a second assist ratio,
when transitioning from the first control mode to the second control mode, the control device starts to change the assist ratio from the first assist ratio to the second assist ratio at a change start position between a first angular position and a second angular position, the first angular position being an angular position obtained by adding 90 degrees to an angular position of the crankshaft corresponding to an uppermost point on a trajectory of the pedal, and the second angular position being an angular position obtained by adding 135 degrees to the angular position of the crankshaft corresponding to the uppermost point, and
the control device changes the assist ratio such that the assist ratio reaches the second assist ratio at a change end position obtained by adding at least 45 degrees to the change start position.

2. The drive system for the electric assisted bicycle according to claim 1, wherein
an angular difference between the change start position and the change end position is equal to or less than 135 degrees.

3. The drive system for the electric assisted bicycle according to claim 1, wherein
an angular difference between the change start position and the change end position is equal to or more than 60 degrees.

4. The drive system for the electric assisted bicycle according to claim 1, wherein
the change end position is between an angular position obtained by adding 135 degrees to the uppermost point and an angular position obtained by adding 225 degrees to the uppermost point.

5. The drive system for the electric assisted bicycle according to claim 1, wherein
the change end position is an angular position obtained by adding an angle equal to or less than 270 degrees to the uppermost point.

6. The drive system for the electric assisted bicycle according to claim 5, wherein
the change end position is an angular position obtained by adding an angle equal to or less than 225 degrees to the uppermost point.

7. The drive system for the electric assisted bicycle according to claim 1, wherein
when the pedal is located between the change start position and the change end position, the control device calculates the assist ratio such that the assist ratio gradually approaches the second assist ratio from the first assist ratio.

8. The drive system for the electric assisted bicycle according to claim 1, further comprising a sensor that detects an amount of change in the angular position of the crankshaft, wherein
when the pedal is located between the change start position and the change end position, the control device calculates the assist ratio based on the amount of change in the angular position of the crankshaft.

9. The drive system for the electric assisted bicycle according to claim 8, wherein
the control device calculates a rate of change in the assist ratio based on a difference between the first assist ratio and the second assist ratio and an angular difference between the change start position and the change end position.

10. An electric assisted bicycle, comprising:
the drive system according to claim 1; and
a wheel that receives an assist torque from the electric motor.

11. A control method for an electric assisted bicycle that controls an electric motor based on an assist ratio according to a control mode and pedaling force detected by a sensor and includes a first control mode and a second control mode as the control mode of the electric motor, the first control mode controlling the electric motor based on a first assist ratio, the second control mode controlling the electric motor based on a second assist ratio, comprising:
starting to change the assist ratio, when transitioning from the first control mode to the second control mode, from the first assist ratio to the second assist ratio at a change start position between a first angular position and a second angular portion, the first angular position being obtained by adding 90 degrees to an angular position of a crankshaft corresponding to an uppermost point of a trajectory of a pedal, and the second angular position being obtained by adding 135 degrees to the angular position of the crankshaft corresponding to the uppermost point; and
changing the assist ratio such that the assist ratio reaches the second assist ratio at a change end position obtained by adding at least 45 degrees to the change start position.

12. A non-transitory information storage medium storing a program causing a computer to function as a control device that controls an electric motor based on an assist ratio according to a control mode and pedaling force detected by a sensor and includes a first control mode and a second assist ratio as the control mode of the electric motor, the control device controlling, in the first control mode, the electric motor based on a first assist ratio, the control device controlling, in the second control mode, the electric motor based on a second assist ratio, the program causing the computer to:
start to change the assist ratio, when transitioning from the first control mode to the second control mode, from the first assist ratio to the second assist ratio at a change start position between a first angular position and a second angular position, the first angular position being obtained by adding 90 degrees to an angular position of a crankshaft corresponding to an uppermost point of a trajectory of a pedal, the second angular position being an angular position obtained by adding 135 degrees to the angular position of the crankshaft corresponding to the uppermost point; and
change the assist ratio such that the assist ratio reaches the second assist ratio at a change end position obtained by adding at least 45 degrees to the change start position.
